(19) United States
(12) Patent Application Publication
(10) Pub. No.: US 2023/0170471 A1
(43) Pub. Date: Jun. 1, 2023

(54) PATTERNED MULTILAYERED ELECTRODES

(71) Applicant: EnPower, Inc., Indianapolis, IN (US)

(72) Inventors: Adrian YAO, Palo Alto, CA (US); Donald PILE, Phoenix, AZ (US); Raymundo ROIG, Phoenix, AZ (US)

(21) Appl. No.: 18/059,553

(22) Filed: Nov. 29, 2022

Related U.S. Application Data
(60) Provisional application No. 63/283,785, filed on Nov. 29, 2021.

(51) Int. Cl. H01M 4/36; H01M 4/62; H01M 50/46

(52) U.S. Cl. CPC H01M 4/366; H01M 4/621; H01M 50/461; H01M 2004/025

(57) ABSTRACT

A patterned multilayered electrode includes at least one electrode layer comprising an array of cavities, and at least one electrode layer comprising a plurality of protrusions interlocked with the array of cavities. In some examples, a patterned multilayered electrode includes a first active material layer, a second active material layer comprising an array of cavities, and a separator layer comprising a plurality of protrusions interlocked with the cavities of the second active material layer. In some examples, a patterned multilayered electrode includes a first active material layer comprising an array of cavities and a second active material layer comprising a plurality of protrusions interlocked with the cavities of the first active material layer.

### CROSS-REFERENCES

The following applications and materials are incorporated herein, in their entireties, for all purposes: U.S. Provisional Patent Application Ser. No. 63/283,785, filed Nov. 29, 2021.

### FIELD

This disclosure relates to systems and methods for electrochemical cells. More specifically, the disclosed embodiments relate to multilayered electrodes.

### INTRODUCTION

Environmentally friendly sources of energy have become increasingly critical, as fossil fuel-dependency becomes less desirable. Most non-fossil fuel energy sources, such as solar power, wind, and the like, require some sort of energy storage component to maximize usefulness. Accordingly, battery technology has become an important aspect of the future of energy production and distribution. Most pertinent to the present disclosure, the demand for secondary (i.e., rechargeable) batteries has increased. Various combinations of electrode materials and electrolytes are used in these types of batteries, such as lead acid, nickel cadmium (NiCad), nickel metal hydride (NiMH), nickel manganese cobalt oxide (NMC), nickel cobalt aluminum oxide (NCA), lithium ion (Li-ion), and lithium-ion polymer (Li-ion polymer). Solvents commonly used in manufacturing processes for electrodes and electrochemical cells are expensive and may be harmful to the environment.

### SUMMARY

The present disclosure provides systems, apparatuses, and methods relating to patterned multilayered electrodes.

In some examples, an electrode in accordance with aspects of the present disclosure includes: a current collector; a first active material layer disposed on the current collector; a second active material layer disposed on the first active material layer; and a plurality of cavities formed on an exterior surface of the electrode, wherein a depth of the cavities is at least half of a thickness of the second active material layer.

In some examples, an electrode in accordance with aspects of the present disclosure includes: a current collector; a first active material layer disposed on the current collector, the first active material layer comprising a plurality of cavities formed on a top surface of the first active material layer; and a second active material layer disposed on the first active material layer, the second active material layer comprising a plurality of protrusions interlocked with the cavities of the first active material layer.

In some examples, a method of manufacturing an electrode in accordance with aspects of the present disclosure includes: providing a substrate; applying a first active material layer onto the substrate, the first active material layer comprising a first plurality of active material particles and a first binder; applying a second active material layer onto the first active material layer, the second active material layer comprising a second plurality of active material particles and a second binder; and forming a plurality of cavities on a top surface of the second active material layer by pressing an embossed mold against the electrode, wherein a depth of the resulting cavities is at least half of a thickness of the second active material layer.

Features, functions, and advantages may be achieved independently in various embodiments of the present disclosure, or may be combined in yet other embodiments, further details of which can be seen with reference to the following description and drawings.

### BRIEF DESCRIPTION OF THE DRAWINGS

FIG. 1 is a schematic view of an illustrative electrochemical cell in accordance with aspects of the present disclosure.

FIG. 2 is a schematic view of a first illustrative patterned multilayered electrode in accordance with aspects of the present disclosure.

FIG. 3 is an isometric view of a first illustrative pattern for a top electrode layer suitable for use with the electrodes of FIG. 2.

FIG. 4 is an isometric view of a second illustrative pattern for a top electrode layer suitable for use with the electrodes of FIG. 2.

FIG. 5 is an isometric view of a third illustrative pattern for a top electrode layer suitable for use with the electrodes of FIG. 2.

FIG. 6 is an isometric view of a fourth illustrative pattern for a top electrode layer suitable for use with the electrodes of FIG. 2.

FIG. 7 is a side schematic view of an electrode patterned according to the pattern depicted in FIG. 6.

FIG. 8 is a schematic view of the first illustrative patterned multilayered electrode of FIG. 2, further comprising an integrated ceramic separator layer.

FIG. 9 is a schematic view of a second illustrative patterned multilayered electrode in accordance with aspects of the present disclosure.

FIG. 10 is a schematic view of the second illustrative patterned multilayered electrode of FIG. 9, further comprising a separator.

FIG. 11 is a flow chart depicting steps of a first illustrative method for manufacturing a patterned multilayered electrode similar to the electrode of FIGS. 2 and 3 according to the present teachings.

FIG. 12 is a schematic view of a first illustrative manufacturing system for manufacturing patterned electrodes in accordance with aspects of the present disclosure.

FIG. 13 is a schematic view of a second illustrative manufacturing system for manufacturing patterned electrodes in accordance with aspects of the present disclosure.

FIG. 14 is a sectional view of an illustrative electrode undergoing a calendering process in accordance with aspects of the present disclosure.

FIG. 15 is a flow chart depicting steps of a second illustrative method for manufacturing a patterned multilayered electrode similar to the electrode of FIGS. 9 and 10 according to the present teachings.

FIG. 16 is a schematic diagram of an illustrative manufacturing system including two die slots suitable for manufacturing electrodes and electrochemical cells of the present disclosure.

FIG. 17 is a schematic diagram of an illustrative manufacturing system including three die slots suitable for manufacturing electrodes and electrochemical cells of the present disclosure.

### DETAILED DESCRIPTION

Various aspects and examples of patterned multilayered electrodes, as well as related methods, are described below and illustrated in the associated drawings. Unless otherwise specified, a multilayered electrode in accordance with the present teachings, and/or its various components, may contain at least one of the structures, components, functionalities, and/or variations described, illustrated, and/or incorporated herein. Furthermore, unless specifically excluded, the process steps, structures, components, functionalities, and/or variations described, illustrated, and/or incorporated herein in connection with the present teachings may be included in other similar devices and methods, including being interchangeable between disclosed embodiments. The following description of various examples is merely illustrative in nature and is in no way intended to limit the disclosure, its application, or uses. Additionally, the advantages provided by the examples and embodiments described below are illustrative in nature and not all examples and embodiments provide the same advantages or the same degree of advantages.

This Detailed Description includes the following sections, which follow immediately below: (1) Definitions; (2) Overview; (3) Examples, Components, and Alternatives; (4) Advantages, Features, and Benefits; and (5) Conclusion. The Examples, Components, and Alternatives section is further divided into subsections, each of which is labeled accordingly.

### Definitions

The following definitions apply herein, unless otherwise indicated.

“Comprising,” “including,” and “having” (and conjugations thereof) are used interchangeably to mean including but not necessarily limited to, and are open-ended terms not intended to exclude additional, unrecited elements or method steps.

Terms such as “first”, “second”, and “third” are used to distinguish or identify various members of a group, or the like, and are not intended to show serial or numerical limitation.

“AKA” means “also known as,” and may be used to indicate an alternative or corresponding term for a given element or elements.

“Elongate” or “elongated” refers to an object or aperture that has a length greater than its own width, although the width need not be uniform. For example, an elongate slot may be elliptical or stadium-shaped, and an elongate candlestick may have a height greater than its tapering diameter. As a negative example, a circular aperture would not be considered an elongate aperture.

“Coupled” means connected, either permanently or releasably, whether directly or indirectly through intervening components.

“Resilient” describes a material or structure configured to respond to normal operating loads (e.g., when compressed) by deforming elastically and returning to an original shape or position when unloaded.

“Rigid” describes a material or structure configured to be stiff, non-deformable, or substantially lacking in flexibility under normal operating conditions.

“Elastic” describes a material or structure configured to spontaneously resume its former shape after being stretched or expanded.

Directional terms such as “up,” “down,” “vertical,” “horizontal,” and the like should be understood in the context of the particular object in question. For example, an object may be oriented around defined X, Y, and Z axes. In those examples, the X-Y plane will define horizontal, with up being defined as the positive Z direction and down being defined as the negative Z direction.

“Providing,” in the context of a method, may include receiving, obtaining, purchasing, manufacturing, generating, processing, preprocessing, and/or the like, such that the object or material provided is in a state and configuration for other steps to be carried out.

In this disclosure, one or more publications, patents, and/or patent applications may be incorporated by reference. However, such material is only incorporated to the extent that no conflict exists between the incorporated material and the statements and drawings set forth herein. In the event of any such conflict, including any conflict in terminology, the present disclosure is controlling.

### Overview

In general, an electrode in accordance with the present teachings includes a first electrode layer comprising a plurality of cavities arranged in an array formed on a top surface of the first electrode layer, and a second electrode layer comprising a plurality of protrusions interlocked with the plurality of cavities. In some examples, the first electrode layer comprises an active material layer and the second electrode layer comprises an active material layer. In some examples, the first electrode layer comprises an active material layer and the second electrode layer comprises a separator layer.

The first electrode layer may include a plurality of cavities arranged in an array formed on the surface of the electrode layer wherein a depth of the cavities is at least half of a thickness of the first electrode layer. The plurality of cavities may comprise perforations, grooves, holes, channels, and/or any other suitable discontinuities within the surface of the first electrode layer. The plurality of cavities may have any suitable cross sections, such as circular, square, rectangular, ovular, triangular, polygonal, oblong, irregular, and/or the like. In some examples, the cavities may have substantially circular and/or elliptical cross sections in a plane defined by the first electrode layer. In some examples, the cavities have a substantially cruciform or “plus-shaped” cross section (e.g., similar to a Phillips-head screw) in the plane defined by the first electrode layer. In some examples, cavity walls defining the cavities are tapered, such that a diameter of each cavity is larger at a top (e.g., outermost) surface of the first electrode layer and lower at a bottom surface of the first electrode layer.

The cavities may be arranged to form arrays of cavities within the first electrode layer. In some examples, the cavities comprise groove structures extending a length and/or width of the first electrode layer, and the array is a 1-D array. In some examples, the cavities are cylindrical, prismatic, conical, frustoconical, and/or the like, and the array is a 2-D array. In some examples, some cavities have a first shape and some cavities have a second shape, and the cavities are arranged to provide different properties within different areas of the first electrode layer. In some examples, depths of the cavities are non-uniform and varying.

In some examples, a second electrode layer is layered over or applied to the first electrode layer, such that the second electrode layer comprises a plurality of protrusions interlocked with the plurality of cavities. In other words, the second electrode layer may be layered onto the second first electrode layer, filling the plurality of cavities and forming a smooth external electrode surface. Accordingly, the first electrode layer and the second electrode layer may collectively comprise an interlocking region including a plurality of cavities interlocked or interpenetrated with a plurality of protrusions.

In some examples, the first electrode layer is a first active material layer, and comprises a first plurality of active material particles adhered together by a first binder. In some examples, the second electrode layer is a second active material layer and comprises a second plurality of active material particles adhered together by a second binder. The first and second pluralities of active material particles may comprise active materials having different properties, which may improve electrochemical performance of the electrode. In examples wherein the electrode is an anode, the first and second pluralities of active material particles may comprise graphite (artificial or natural), hard carbon, titanate, titania, transition metals in general, elements in group 14 (e.g., carbon, silicon, tin, germanium, etc.), oxides, sulfides, transition metals, halides, and/or chalcogenides. In examples wherein the electrode is a cathode, the first and second pluralities of active material particles may comprise transition metals (for example, nickel, cobalt, manganese, copper, zinc, vanadium, chromium, iron), and their oxides, phosphates, phosphites, silicates, alkalines and alkaline earth metals, aluminum, aluminum oxides and aluminum phosphates, halides and/or chalcogenides.

In some examples, the second electrode layer comprises an integrated ceramic separator layer, and comprises a plurality of electrochemically inactive ceramic particles adhered together by a third binder. The integrated ceramic separator layer may be configured to electrically insulate the electrode from adjacent electrodes in an electrochemical cell. The electrochemically inactive particles may comprise any suitable inorganic material, such as ceramics such as aluminum oxide (i.e., alumina (α-Al₂O₃)), corundum, calcined, tabular, synthetic boehmite, silicon oxides or silica, zirconia, and/or the like. In some examples, the electrochemically inactive ceramic particles are electrically non-conductive.

In some examples, the electrode comprises further electrode layers disposed above or below the first and second electrode layers. In some examples, the first electrode layer is an active material layer, the second electrode layer is an integrated ceramic separator layer, and the electrode comprises an additional active material layer disposed beneath the first electrode layer (e.g., between the first electrode layer and a current collector substrate). In some examples, the first electrode layer is an active material layer, the second electrode layer is an active material layer, and the electrode comprises an integrated ceramic separator layer layered onto the second electrode layer.

In some examples, a method of manufacturing a patterned electrode includes: providing a substrate, applying a first active material slurry layer to the substrate, applying a second active material slurry layer to the first active material slurry layer, optionally evaporating solvent from the first active material slurry layer and the second active material slurry layer, and forming a plurality of cavities arranged in an array on the surface of the second active material layer by pressing an embossed mold against the electrode, wherein a depth of the cavities is at least half of a thickness of the second active material layer. In some examples, a method of manufacturing a patterned electrode further includes layering a separator slurry comprising a plurality of inorganic, electrically inactive ceramic particles onto the second active material slurry layer.

In some examples, a method of manufacturing a patterned electrode includes: providing a substrate, applying a first active material slurry layer to the substrate, optionally evaporating solvent from the first active material slurry layer, forming a plurality of cavities arranged in an array on the surface of the first active material slurry layer, coating a second active material slurry layer onto the first active material slurry layer, optionally coating a separator layer onto the second active material slurry layer, and optionally drying and/or calendering the electrode.

### Examples, Components, and Alternatives

The following sections describe selected aspects of illustrative patterned multilayered electrodes as well as related systems and/or methods. The examples in these sections are intended for illustration and should not be interpreted as limiting the scope of the present disclosure. Each section may include one or more distinct embodiments or examples, and/or contextual or related information, function, and/or structure.

### A. Illustrative Electrochemical Cell

This section describes an electrochemical cell including an electrode according to the present teachings. The electrochemical cell may be any bipolar electrochemical device, such as a battery (e.g., lithium-ion battery, secondary battery, etc.).

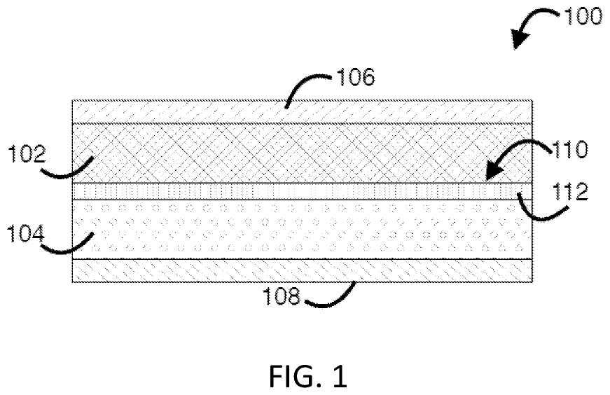

Referring now to FIG. 1, an electrochemical cell 100 is illustrated schematically in the form of a lithium-ion battery. Electrochemical cell 100 includes a positive and a negative electrode, namely a cathode 102 and an anode 104. The cathode and anode are sandwiched between a pair of current collectors 106, 108, which may comprise metal foils or other suitable substrates. Current collector 106 is electrically coupled to cathode 102, and current collector 108 is electrically coupled to anode 104. Current collectors 106 and 108 enable the flow of electrons, and therefore electrical current, into and out of each electrode. An electrolyte 110 disposed throughout the electrodes enables the transport of ions between cathode 102 and anode 104. Electrolyte 110 facilitates an ionic connection between cathode 102 and anode 104. In some examples, electrolyte 110 includes a liquid solvent and a solute of dissolved ions. In some examples, electrolyte 110 includes a gel solvent and a solute of dissolved ions. In some examples, electrolyte 110 includes a solid ion conductor intermixed with active material particles of cathode 102 and anode 104.

Electrolyte 110 is assisted by a separator 112, which physically partitions the space between cathode 102 and anode 104. Separator 112 electrically isolates cathode 102 and anode 104 from each other, preventing shorting within the electrochemical cell. Separator 112 is permeable to electrolyte 110, and enables the movement (AKA flow) of ions within electrolyte 10 and between the two electrodes. As described further below, separator 112 may be integrated within one or both of cathode 102 and anode 104. In some examples, separator 112 comprises a layer of ceramic particles applied to a top surface of an electrode (i.e., cathode 102 or anode 104), such that the ceramic particles of separator 112 are interpenetrated or intermixed with active material particles of cathode 102 or anode 104. As separator 112 insulates the electrodes from each other, ceramic particles included in separator 112 may be electrically non-conductive and electrochemically inactive. In some examples, electrolyte 110 includes a polymer gel or solid ion conductor, augmenting or replacing (and performing the function of separator 112).

Cathode 102 and anode 104 are composite structures, which comprise active material particles, binders, conductive additives, and pores (i.e., void space) into which electrolyte 110 may penetrate. An arrangement of the constituent parts of an electrode is referred to as a microstructure, or more specifically, an electrode microstructure.

In some examples, such as when the electrode is a cathode, the binder is a polymer, e.g., polyvinylidene difluoride (PVdF), and the conductive additive typically includes a nanometer-sized carbon, such as carbon black, carbon nanotubes, micron-sized carbon (e.g., flake graphite), and/or the like. In some examples, such as when the electrode is an anode, the binder is a mixture of carboxyl-methyl cellulose (CMC) and a long chain polymer, such as styrene-butadiene rubber (SBR), polyacrylic acid (PAA), polyvinyl alcohol (PVA), and/or the like. In some examples, the conductive additive includes a carbon black, a ketjen black, a graphitic carbon, a low dimensional carbon (e.g., carbon nanotubes), and/or a carbon fiber.

In some examples, the chemistry of the active material particles differs between cathode 102 and anode 104. For example, anode 104 may include active material particles comprising graphite (artificial or natural), hard carbon, lithium metal, silicon, silicon oxide, titanate, titania, transition metals in general, elements in group 14 (e.g., carbon, silicon, tin germanium, etc.), oxides, sulfides, halides, and/or chalcogenides. On the other hand, cathode 102 may include active material particles comprising transition metals (for example, nickel, cobalt, manganese, copper, zinc, vanadium, chromium, iron), and their oxides, phosphates, phosphites, silicates, alkalines and alkaline earth metals, aluminum, aluminum oxides and aluminum phosphates, halides and/or chalcogenides.

In an electrochemical device such as electrochemical cell 100, active materials participate in an electrochemical reaction or process with a working ion to store or release energy. For example, in a lithium-ion battery, the working ions are lithium ions. For electrochemical cell 100 to properly function as a secondary battery, active material particles in both cathode 102 and anode 104 must be capable of storing and releasing ions through the respective processes known as lithiating and delithiating. Some active materials (e.g., layered oxide materials, graphitic carbon, etc.) fulfill this function by intercalating lithium ions between crystal layers or within interstitial spaces within a crystal lattice. Other active materials may have alternative lithiating and delithiating mechanisms (e.g., alloying, conversion, etc.).

When electrochemical cell 100 is being charged, anode 104 accepts lithium ions while cathode 102 donates lithium ions. In other words, lithium ions stored by the cathode travel to and are stored by the anode, lithiating the anode and delithiating the cathode. When a cell is being discharged, anode 104 donates lithium ions while cathode 102 accepts lithium ions. In other words, lithium ions stored by the anode travel to and are stored by the cathode, lithiating the cathode and delithiating the anode. Each composite electrode (i.e., cathode 102 and anode 104) has a rate at which it donates or accepts lithium ions that depends on properties extrinsic to the electrode (e.g., the current passed through each electrode, the conductivity of electrolyte 110) as well as properties intrinsic to the electrode (e.g., a solid state diffusion constant of the electrode and of active material particles in the electrode; the electrode microstructure or tortuosity; the charge transfer rate at which lithium ions move from being solvated in the electrolyte to being intercalated in the active material particles of the electrode; etc.).

During either mode of operation (charging or discharging), anode 104 or cathode 102 may donate or accept lithium ions at a limiting rate, where rate is defined as lithium ions per unit time, per unit current. For example, during charging, anode 104 may accept lithium at a first rate, and cathode 102 may donate lithium at a second rate. When the second rate is less than the first rate, the second rate of the cathode would be a limiting rate. In some examples, the differences in rates may be so dramatic as to limit the overall performance of the lithium-ion battery (e.g., cell 100). Reasons for the differences in rates may depend on an energy required to lithiate or delithiate a quantity of lithium-ions per mass of active material particles; a solid-state diffusion coefficient of lithium ions in an active material particle; and/or a particle size distribution of active material within a composite electrode. In some examples, charge and discharge rates are influenced by an impedance of the separator, which may depend on a total thickness of the separator, a particle size distribution of the separator particles, a porosity of the separator microstructure, a porosity of ceramic particles included within the separator, and/or a total density of the separator. In some examples, additional or alternative factors may contribute to the electrode microstructure and affect these rates.

Electrochemical cell 100 may include packaging (not shown). For example, packaging (e.g., a prismatic can, stainless steel tube, polymer pouch, etc.) may be utilized to constrain and position cathode 102, anode 104, current collectors 106 and 108, electrolyte 110, and separator 112.

### B. First Illustrative Multilayered Electrode

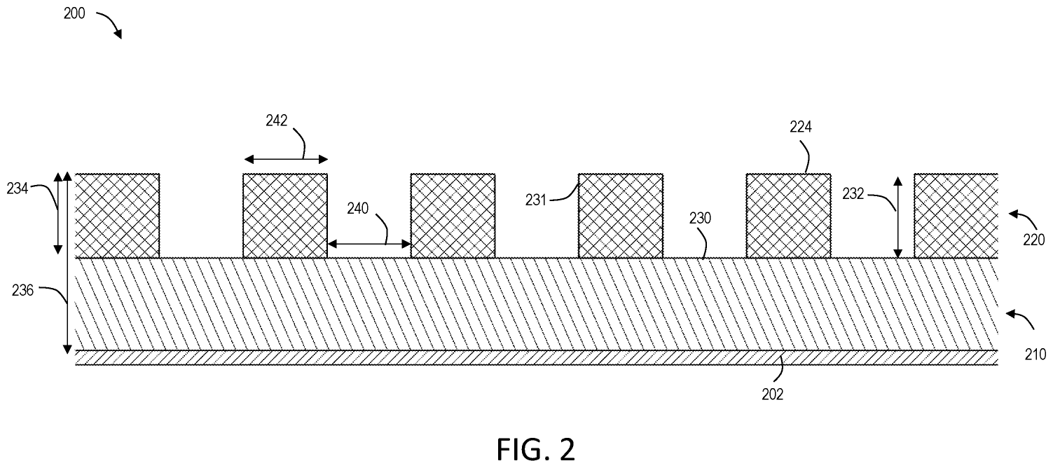

As shown in FIGS. 2-8, this section describes a first illustrative patterned multilayered electrode 200. The first illustrative patterned multilayered electrode is an electrode suitable for use in electrochemical cell 100, described above.

Patterned multilayered electrode 200 includes a current collector 202, a first active material layer 210 layered onto and directly contacting the current collector, and a second active material layer 220 layered onto and directly contacting the first active material layer. Current collector 202 may comprise a metal foil or any other suitable substrate. First active material layer 210 includes a first plurality of active material particles adhered together by a first binder. Second active material layer 220 includes a second plurality of active material particles adhered together by a second binder.

Second active material layer 220 includes a plurality of cavities 230 arranged in an array formed on an exterior surface 224 of multilayered electrode 200. A depth 232 of the cavities is at least half of a thickness 234 of the second active material layer. The plurality of cavities may comprise perforations, grooves, holes, channels, and/or any other suitable discontinuities within the surface of the second active material layer. The plurality of cavities may have any suitable cross-sectional shape, such as circular, elliptical, cruciform, plus-shaped, star-shaped, oblong, rectangular, square, triangular, and/or the like. In some examples, walls 231 of the cavities are tapered, such that a diameter of each cavity is larger at a top (e.g., outermost) of the cavity and lower at a bottom (e.g., closer to the first active material layer) of the cavity.

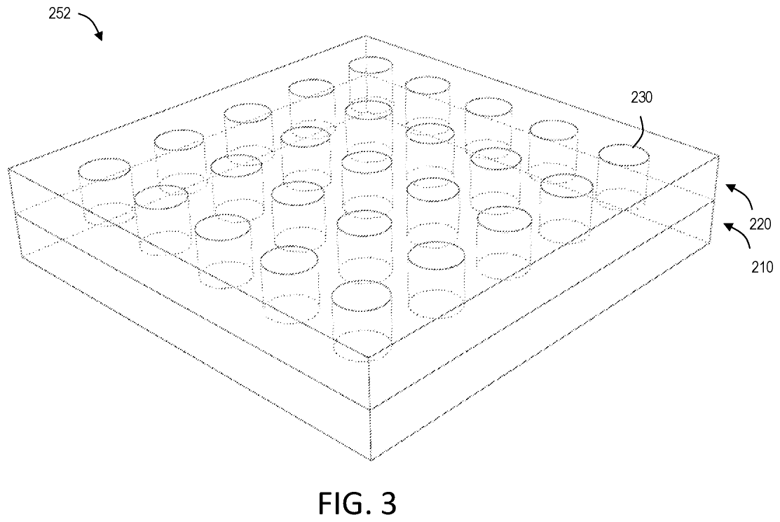

In some examples, the cavities are arranged to form arrays 252, 254, 256 of cavities 230 within the second active material layer. Examples of suitable arrays are depicted in FIGS. 3-6. In some examples, suitable arrays are symmetric, and include cavities arranged in rows and columns.

In some examples, such as in the example depicted in FIG. 3, the cavities are substantially cylindrical in shape and arranged in a two-dimensional array 252.

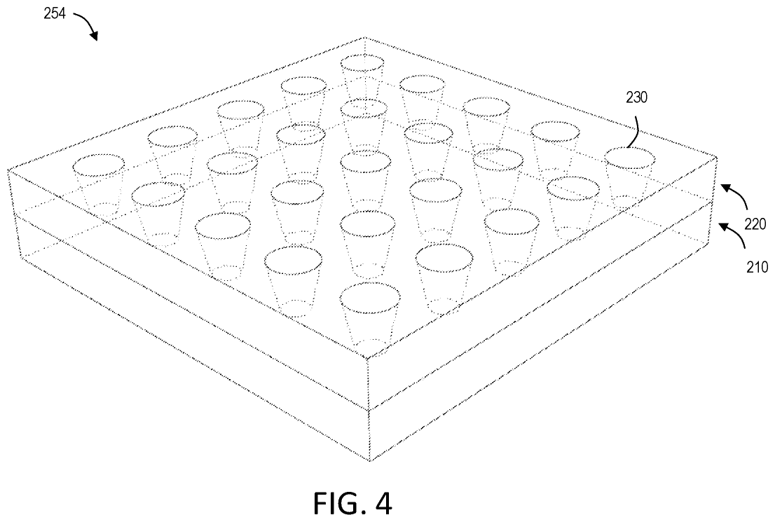

In some examples, such as in the example depicted in FIG. 4, the cavities are substantially frustoconical in shape and arranged in a two-dimensional array 254.

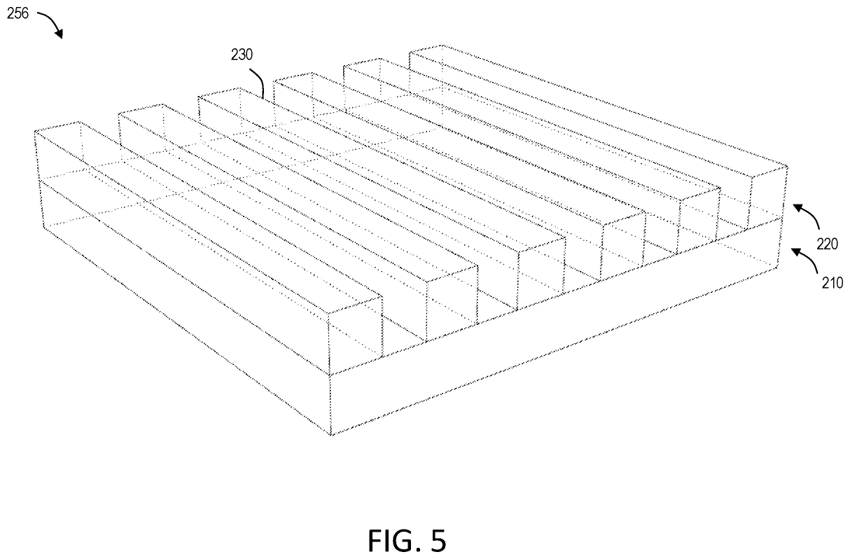

In some examples, such as in the example depicted in FIG. 5, the cavities comprise groove structures extending a length and/or width of the second active material layer, and are arranged in a one-dimensional array 256.

Cavities 230 may have any suitable dimensions, provided the cavities have a depth of at least half of a thickness 234 of the second active material layer. Thickness 234 of the second active material layer may be from 20 μm to a total thickness 236 of the electrode. Accordingly, the cavities may have a depth 238 from 10 μm to the thickness 236 of the electrode layer. The thickness 236 of the electrode may be from 50 μm to 200 μm. Cavities 230 may have any suitable width and/or diameter 240. In some examples, cavities 230 have a width 240 from 10 μm to 100 μm. Cavities may be separated by any suitable wall thickness 242, which may be from 50 μm to 1000 μm.

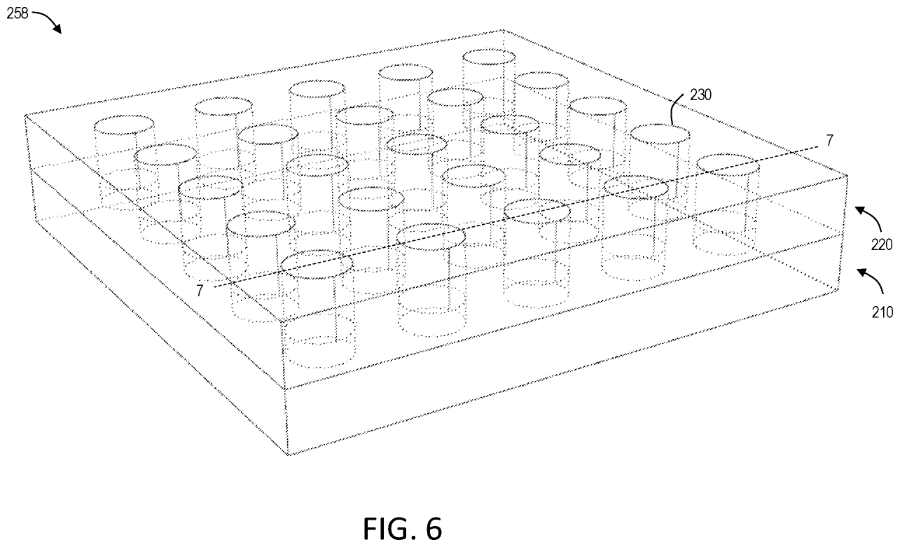

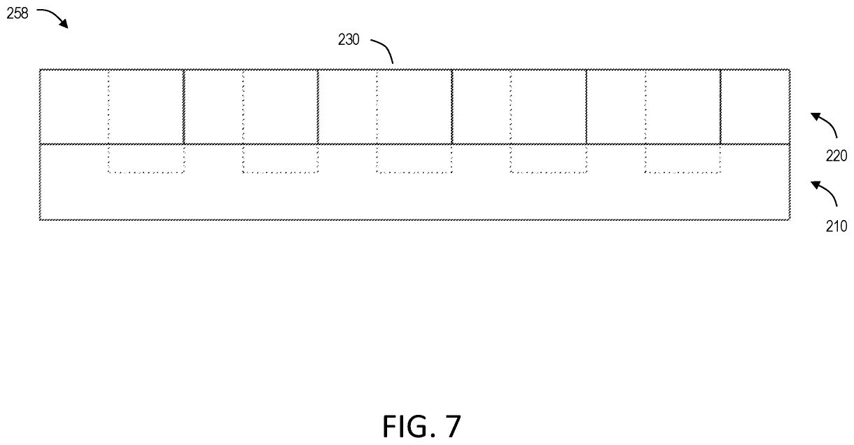

In some examples, cavities 230 have a depth greater than a thickness of the second active material layer, and extend into the first active material layer, as depicted in FIGS. 6 and 7. In these examples, the cavities may provide conduction channels into the first active material layer, facilitating ionic conduction through the electrode. FIG. 6 depicts a plurality of cylindrical cavities arranged in a two-dimensional array 258. The cylindrical cavities depicted in FIG. 6 extend partially into the first active material layer. FIG. 7 depicts a cross section of array 258.

While the arrays described above are uniform in cavity shape, depth, and arrangement, cavities may have varied shapes, sizes, and distributions. In some examples, shapes of cavities included in the second active material layer vary, and cavities are arranged to provide different properties to different layers of the electrode. In some examples, depths of the cavities may be non-uniform and varying.

The first and second pluralities of active material particles may comprise active materials having different properties, which may improve electrical properties of the electrode. In examples wherein the electrode is an anode, the first and second pluralities of active material particles may comprise graphite (artificial or natural), hard carbon, titanate, titania, transition metals in general, elements in group 14 (e.g., carbon, silicon, tin, germanium, etc.), oxides, sulfides, transition metals, halides, and/or chalcogenides. In examples wherein the electrode is a cathode, the first and second pluralities of active material particles may comprise transition metals (for example, nickel, cobalt, manganese, copper, zinc, vanadium, chromium, iron), and their oxides, phosphates, phosphites, silicates, alkalines and alkaline earth metals, aluminum, aluminum oxides and aluminum phosphates, halides and/or chalcogenides.

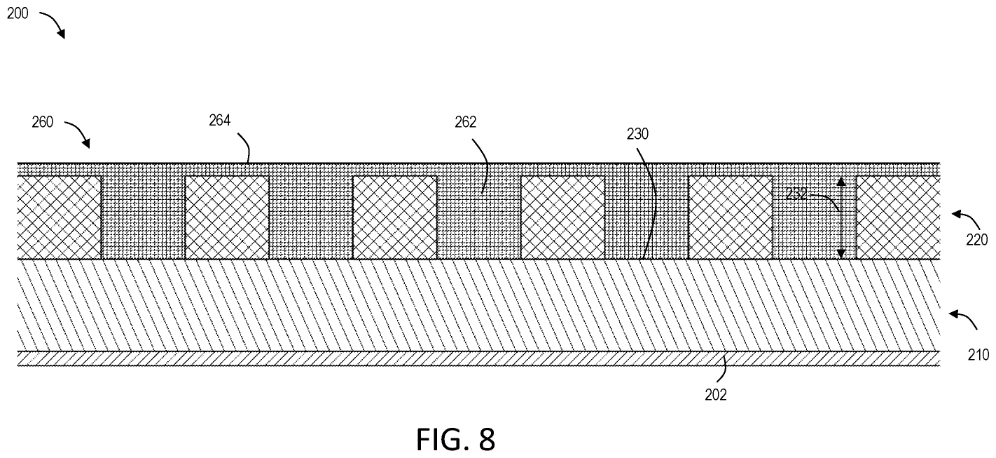

In some examples, as depicted in FIG. 8, an integrated ceramic separator layer 260 is layered onto the second active material layer, filling the plurality of cavities with protrusions 262 and forming a smooth external electrode surface 264. The integrated ceramic separator may comprise a plurality of electrochemically inactive ceramic particles adhered together by a third binder. The integrated ceramic separator layer may be configured to electrically insulate the electrode from adjacent electrodes in an electrochemical cell. The electrochemically inactive particles may comprise any suitable inorganic material, such as ceramics such as aluminum oxide (i.e., alumina (a-Al₂O₃)), corundum, calcined, tabular, synthetic boehmite, silicon oxides or silica, zirconia, and/or the like. In some examples, the electrochemically inactive ceramic particles are electrically non-conductive.

Protrusions 262 of integrated ceramic separator layer 260 fill cavities 230, interlocking the second active material layer and the integrated ceramic separator layer. Protrusions 262 may completely fill cavities 230, forming a mechanically robust interface that is capable of withstanding stresses, such as those due to electrode expansion and contraction. Additionally, the non-planar surfaces defined by protrusions 262 and cavities 230 represent an increased total surface area of an interface boundary between the second active material layer and the integrated ceramic separator layer, which may provide reduced interfacial resistance and may increase ion mobility through the electrode.

### C. Second Illustrative Multilayered Electrode

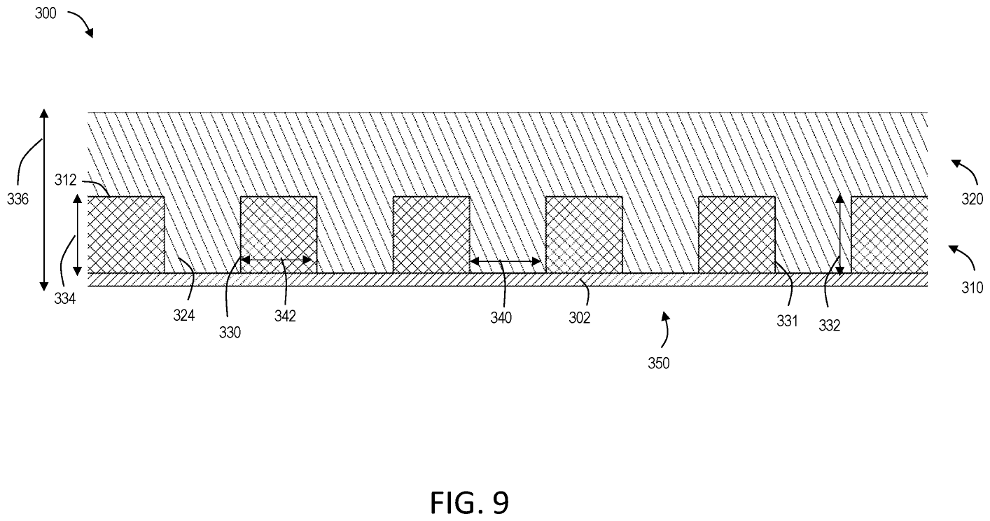

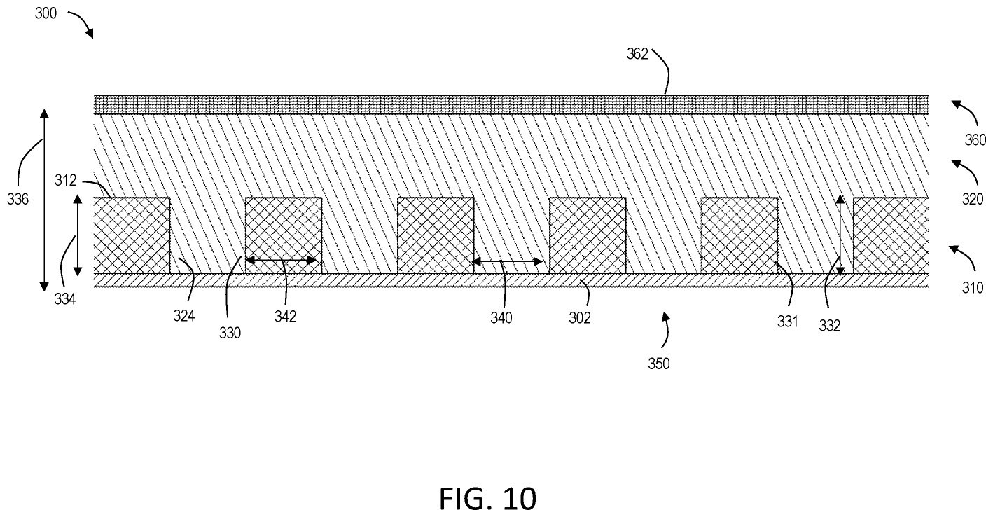

As shown in FIGS. 9-10, this section describes an illustrative second patterned multilayered electrode 300 suitable for use in electrochemical cell 100.

Patterned multilayered electrode 300 includes a current collector 302, a first active material layer 310 layered onto and directly contacting the current collector, and a second active material layer 320 layered onto and directly contacting the first active material layer. Current collector 302 may comprise a metal foil or any other suitable substrate. First active material layer 310 includes a first plurality of active material particles adhered together by a first binder. Second active material layer 320 includes a second plurality of active material particles adhered together by a second binder.

First active material layer 310 includes a plurality of cavities 330 arranged in an array formed on a top surface 312 of the first active material layer. The second active material layer 320 is layered onto the top surface 312 of the first active material layer 310, filling the plurality of cavities with protrusions 324 comprising the second plurality of active material particles. A depth 332 of the cavities is less than or equal to a thickness 334 of the first active material layer. The plurality of cavities may have any suitable cross-sectional shape, such as circular, elliptical, cruciform, plus-shaped, star-shaped, oblong, rectangular, square, triangular, and/or the like. In some examples, walls 331 of the cavities are tapered, such that a diameter of each cavity is larger at a top (e.g., outermost) of the cavity and lower at a bottom (e.g., closer to the first active material layer) of the cavity. In some examples, the cavities are arranged to form arrays 350 of cavities 330 within the first active material layer. Arrays 350 may be substantially identical to arrays 252-256, depicted in FIGS. 3-5. Accordingly, in some examples, the cavities are substantially cylindrical in shape, and may be arranged in a two-dimensional array. In some examples, the cavities are substantially frustoconical in shape and arranged in a two-dimensional array. In some examples, the cavities comprise groove structures extending a length and/or width of the second active material layer, and are arranged in a one-dimensional array.

Cavities 330 may have any suitable dimensions, provided the cavities have a depth less than or equal to a thickness 334 of the first active material layer. A total thickness 336 of the electrode may be from 50 μm to 200 μm. In some examples, the cavities have a depth 338 from 10 μm to the thickness 336 of the electrode layer. Cavities may have any suitable width and/or diameter 340. In some examples, cavities have a width 340 from 10 μm to 100 μm. Cavities may be separated by any suitable wall thickness 342, such as from 50 μm to 1000 μm.

While the arrays described above are uniform in cavity shape, depth, and arrangement, cavities may have varied shapes, sizes, and distributions. In some examples, shapes of cavities included in the second active material layer vary, and cavities are arranged to provide different properties in different areas of the second active material layer. In some examples, depths of the cavities are non-uniform and varying.

The first and second pluralities of active material particles may comprise active materials having different properties, which may improve electrical properties of the electrode. In some examples, the first plurality of active material particles have a lower lithiation potential than the second plurality of active material particles. In examples wherein the electrode is an anode, the first and second pluralities of active material particles may comprise graphite (artificial or natural), hard carbon, titanite, titania, transition metals in general, elements in group 14 (e.g., carbon, silicon, tin, germanium, etc.), oxides, sulfides, transition metals, halides, and/or chalcogenides. In examples wherein the electrode is an anode, the first plurality of active material particles may have a lower free energy to lithiate than the second plurality of active material particles. In some examples, such as when one or both of the first and second pluralities of active material particles comprise silicon, the patterned structure of the electrode may provide room for lateral expansion of the silicon materials upon lithiation.

In examples wherein the electrode is a cathode, the first and second pluralities of active material particles may comprise transition metals (for example, nickel, cobalt, manganese, copper, zinc, vanadium, chromium, iron), and their oxides, phosphates, phosphites, silicates, alkalines and alkaline earth metals, aluminum, aluminum oxides and aluminum phosphates, halides and/or chalcogenides.

Protrusions 324 of second active material layer 320 fill cavities 330, interlocking the first active material layer and the second active material layer. Protrusions 324 may completely fill cavities 330, forming a mechanically robust interface that is capable of withstanding stresses, such as those due to electrode expansion and contraction. Additionally, the non-planar surfaces defined by protrusions 324 and cavities 330 represent an increased total surface area of an interface boundary between the first active material layer and the second active material layer, which may provide reduced interfacial resistance and may increase ion mobility through the electrode.

In some examples, as depicted in FIG. 10, an integrated ceramic separator layer 360 is layered onto the second active material layer. The integrated ceramic separator may comprise a plurality of electrochemically inactive ceramic particles adhered together by a third binder. The integrated ceramic separator layer may be configured to electrically insulate the electrode from adjacent electrodes in an electrochemical cell. The electrochemically inactive particles may comprise any suitable inorganic material, such as ceramics such as aluminum oxide (i.e., alumina (a-Al₂O₃)), corundum, calcined, tabular, synthetic boehmite, silicon oxides or silica, zirconia, and/or the like. In some examples, the electrochemically inactive ceramic particles are electrically non-conductive.

### D. First Illustrative Manufacturing Method

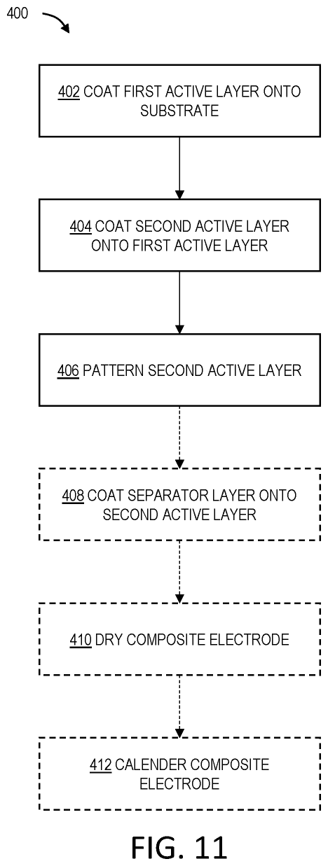

This section describes steps of an illustrative method 400 for manufacturing a patterned multilayered composite electrode; see FIG. 11. Aspects of electrochemical cell 100, electrode 200, and electrode 300 may be utilized in the method steps described below. Where appropriate, reference may be made to components and systems that may be used in carrying out each step. These references are for illustration, and are not intended to limit the possible ways of carrying out any particular step of the method.

FIG. 11 is a flowchart illustrating steps performed in an illustrative method, and may not recite the complete process or all steps of the method. Although various steps of method 400 are described below and depicted in FIG. 11, the steps need not necessarily all be performed, and in some cases may be performed simultaneously or in a different order than the order shown.

Step 402 of method 400 includes coating a first active layer of a composite electrode onto a first side of a substrate, forming an active material composite. The substrate may include any suitable structure and material configured to function as a conductor in a secondary battery of the type described herein. In some examples, the substrate comprises a current collector. In some examples, the substrate comprises a metal foil.

In some examples, the first active layer may include a plurality of first active material particles adhered together by a first binder, the first particles having a first average particle size (or other first particle distribution). In some examples, the composite electrode is an anode suitable for inclusion within an electrochemical cell. In this case, the first particles may comprise graphite (artificial or natural), hard carbon, lithium metal, silicon, silicon oxide, titanate, titania, transition metals in general, elements in group 14 (e.g., carbon, silicon, tin, germanium, etc.), oxides, sulfides, transition metals, halides, and/or chalcogenides. In some examples, the composite electrode is a cathode suitable for inclusion within an electrochemical cell. In this case, the first particles may comprise transition metals (for example, nickel, cobalt, manganese, copper, zinc, vanadium, chromium, iron, etc.), and their oxides, phosphates, phosphites and silicates; alkalines and alkaline earth metals; aluminum, aluminum oxides and aluminum phosphates; halides; chalcogenides, and/or the like. Coating the substrate with the first active layer may be done by causing a current collector substrate and an electrode material composite dispenser to move relative to each other, by causing the substrate to move past an electrode material composite dispenser (or vice versa) that coats the substrate as described below. The composition of material particles in the first active layer and in subsequent electrode material composite layers may be selected to achieve the benefits, characteristics, and results described herein. The resulting electrode material composite may include one or more electrode layers, including a plurality of active material particles, and one or more separator layers, each including a plurality of inorganic material particles.

The coating process of step 402 may include any suitable coating method(s), such as slot die, blade coating, spray-based coating, electrostatic jet coating, or the like. In some examples, the first layer is coated as a wet slurry of solvent, e.g., water or NMP (N-Methyl-2-pyrrolidone), binder, conductive additive, and active material. In some examples, the first layer is coated dry, as an active material with a binder and/or a conductive additive. Step 402 may optionally include drying the first layer of the composite electrode.

Step 404 of method 400 includes coating a second active layer of the active material composite onto the first active layer, forming a multilayered electrode (e.g., stratified structure). In some examples, the second active layer may include a plurality of second active material particles adhered together by a second binder, the second active material particles having a second average particle size (or other second particle distribution). In some examples, the composite electrode is an anode suitable for inclusion within an electrochemical cell. In this case, the first particles may comprise graphite (artificial or natural), hard carbon, lithium metal, silicon, silicon oxide, titanate, titania, transition metals in general, elements in group 14 (e.g., carbon, silicon, tin, germanium, etc.), oxides, sulfides, transition metals, halides, and/or chalcogenides. In some examples, the composite electrode is a cathode suitable for inclusion within an electrochemical cell. In this case, the first particles may comprise transition metals (for example, nickel, cobalt, manganese, copper, zinc, vanadium, chromium, iron, etc.), and their oxides, phosphates, phosphites and silicates; alkalines and alkaline earth metals; aluminum, aluminum oxides and aluminum phosphates; halides; chalcogenides, and/or the like. In some examples, the second layer is coated as a solventless (i.e., dry) layer including a plurality of second active material particles adhered together by a second binder. In some examples, coating the second layer dry includes spraying the dry coating onto the first active material layer using any suitable method, such as electrostatically spraying, particle coating, high-velocity spraying, and/or the like. In some examples, the second layer includes a conductive additive. Step 404 may optionally include drying the second layer of the composite electrode.

In some examples, steps 404 and 406 may be performed substantially simultaneously. For example, the slurries may be extruded through their respective orifices simultaneously. This forms a two-layer slurry bead and coating on the moving substrate. In some examples, difference in viscosities, difference in surface tensions, difference in densities, difference in solids contents, and/or different solvents used between the first active material slurry and the second active material slurry or the separator slurry may be tailored to cause interpenetrating finger structures at the boundary between the composite layers. In some embodiments, the viscosities, surface tensions, densities, solids contents, and/or solvents may be substantially similar. Creation of interpenetrating structures, if desired, may be facilitated by turbulent flow at the wet interface between the first active material slurry and the second active material slurry or the second separator slurry, creating partial intermixing of the two slurries.

To facilitate proper curing in the drying process, the first layer (closest to the current collector) may be configured (in some examples) to be dried from solvent prior to the second layer (further from the current collector) so as to avoid creating skin-over effects and blisters in the resulting dried coatings.

In some examples, an optional third active material layer is included, e.g., for a total of three layers (more or fewer layers may be present). A triple slot-die coating method may be utilized for triple-layered structures. In some examples, any of the described steps may be repeated to form three or more layers. For example, an additional layer or layers may include active materials to form a multilayered electrode structure before adding the separator layer. Any method described herein to impart structure between the first active material layer and the second active material layer may be utilized to form similar structures between any additional layers deposited during the manufacturing process.

Step 406 of method 400 includes patterning the second active material layer. In some examples, patterning the second active material layer includes forming cavities within the second active material layer by any suitable method, such as stamping, carving, boring, and/or the like. In some examples, patterning the second active material layer includes stamping the second active material layer with embossed plates, rollers, and/or the like including arrays of protrusions. In some examples, patterning the second active material layer includes forming cavities in both the second active material layer and an upper portion of the first active material layer. In some examples, forming cavities in the second active material layers includes forming cavities arranged in an array. A depth of the cavities may be at least half of a thickness of the second active material layer. In some example, a depth of the cavities is greater than a thickness of the second active material layer. The plurality of cavities may comprise perforations, grooves, holes, channels, and/or any other suitable discontinuities within the surface of the second active material layer. The plurality of cavities may have any suitable cross-sectional shape, such as circular, elliptical, cruciform, plus-shaped, star-shaped, oblong, rectangular, square, triangular, and/or the like. In some examples, walls of the cavities may be tapered, such that a diameter of each cavity is larger at a top (e.g., outermost) of the cavity and lower at a bottom (e.g., closer to the first active material layer) of the cavity.

In some examples, patterning the second active material layer includes causing the electrode composite and an embossed stamp to move relative to each other. In some examples, patterning the second active material layer includes stamping the second active material layer with embossed rollers. In some examples, patterning the second active material layer includes stamping the second active material layer with embossed plates.

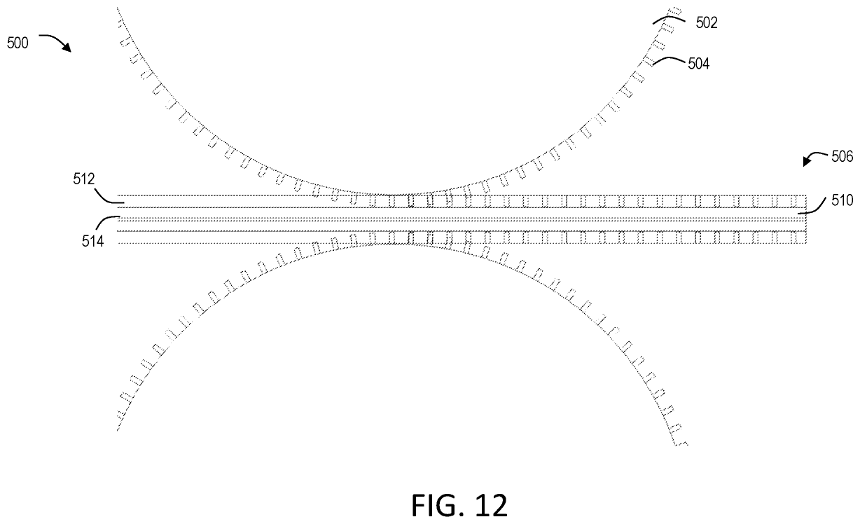

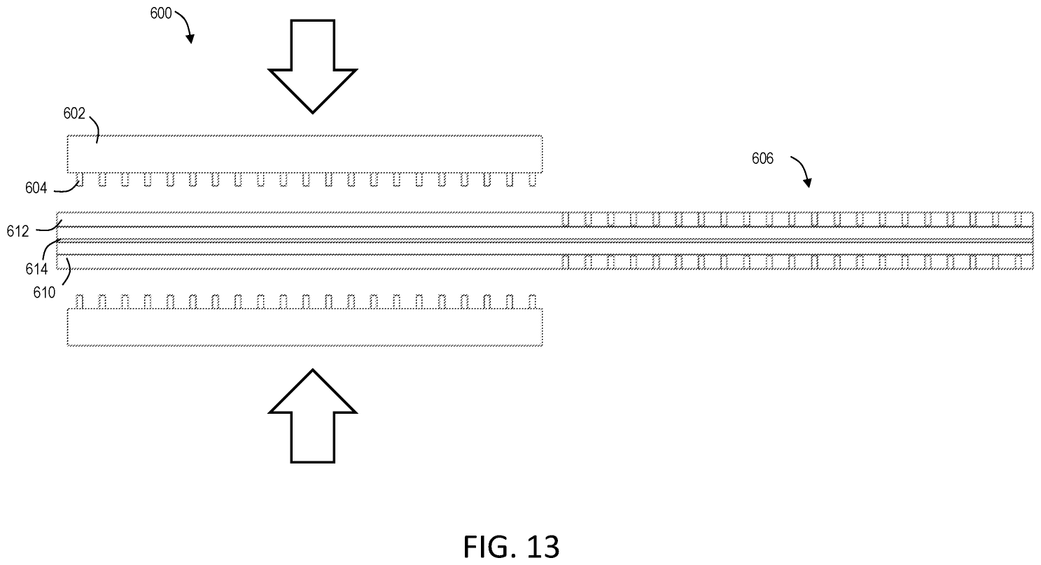

FIGS. 12 and 13 depict illustrative patterning systems suitable for use in method 400. As depicted in FIG. 12, a first patterning system 500 includes one or more embossed rollers 502 including a plurality of castellations 504 configured to stamp, cut, or otherwise form a plurality of cavities within an electrode layer or plurality of electrode layers of a composite electrode 506. Composite electrode 506 may be an example of multilayered patterned electrodes 200, 300, as described above. Composite electrode 506 may be passed between embossed rollers 502 in a reel-to-reel (AKA roll-to-roll fashion). In the example depicted in FIG. 12, the patterning system includes two embossed rollers, which are configured to stamp cavities on electrode layers 510, 512 applied to both sides of a current collector 514. The castellations may have any suitable length, which may be selected to correspond to a thickness of the electrode layers. In some examples, the castellations may have a length greater than half the thickness of the second electrode layer 512. In some examples, the castellations may have a length greater than the thickness of the second electrode layer 512, and may form cavities extending from the second electrode layer into first electrode layer 510. Embossed rollers 502 may include castellations formed using any suitable manufacturing technique, such as subtractive techniques like acid etching, photo etching, embossing, and/or the like.

As depicted in FIG. 13, a second patterning system 600 includes one or more embossed plates 602 including a plurality of castellations 604 configured to stamp, cut, or otherwise form a plurality of cavities within an electrode layer or plurality of electrode layers of a composite electrode 606. Composite electrode 606 may be an example of multilayered patterned electrodes 200, 300, as described above. Composite electrode 606 may be passed between embossed plates 602 in a semi-continuous fashion. Accordingly, composite electrode 606 may be stamped by plates 602 and moved in a caterpillar motion. In the example depicted in FIG. 13, the patterning system includes two embossed plates, which are configured to stamp cavities on electrode layers 610, 612 applied to both sides of a current collector 614. The castellations may have any suitable length, which may be selected to correspond to a thickness of the electrode layers. In some examples, the castellations may have a length greater than half the thickness of the second electrode layer 612. In some examples, the castellations may have a length greater than the thickness of the second electrode layer 612, and may form cavities extending from the second electrode layer into first electrode layer 610. Embossed plates 602 may include castellations formed using any suitable manufacturing technique, such as subtractive techniques like acid etching, photo etching, embossing, and/or the like.

Step 408 of method 400 includes optionally coating a separator layer onto the second active material layer, filling the cavities of the second active material layer and forming a plurality of protrusions adhering the separator layer to the second active material layer. The protrusions may completely fill the cavities, forming a mechanically robust interface that is capable of withstanding stresses, such as those due to electrode expansion and contraction. Additionally, non-planar surfaces defined by protrusions and cavities represent an increased total surface area of an interface boundary between the second active material layer and the separator layer, which may provide reduced interfacial resistance.

The separator layer may include a plurality of ceramic particles adhered together by a third binder, the ceramic particles having a third average particle size (or other third particle distribution). Coating the separator layer onto the second active material layer may include any suitable coating method(s), such as slot die, blade coating, spray-based coating, electrostatic jet coating, or the like. In some examples, the separator layer is coated as a wet slurry of solvent, e.g., water or NMP (N-Methyl-2-pyrrolidone), binder, conductive additive, and active material. In some examples, the separator layer is coated in a dry process, as an active material with a binder and/or a conductive additive. In some examples, coating the separator layer in a dry (e.g., solventless) process includes spraying the dry coating onto the second active material layer using any suitable method, such as electrostatically spraying, particle coating, high-velocity spraying, and/or the like. In some examples, the ceramic particles comprise any suitable inorganic material, such as aluminum oxide (i.e., alumina (a-Al₂O₃)), corundum, calcined, tabular, synthetic boehmite, silicon oxides or silica, zirconia, and/or the like. In some examples, the separator layer is coated as a solventless (i.e., dry) layer including a plurality of ceramic particles adhered together by a third binder.

Method 400 may optionally include drying the composite electrode in step 410. The first active layer, second active layer, and separator layer may experience the drying process as a combined structure. In some examples, drying step 410 includes a form of heating and energy transport to and from the electrode (e.g., convection, conduction, radiation) to expedite the drying process. In some examples, drying step 410 includes causing the coated current collector substrate to move relative to a plurality of heating elements. In some examples, drying step 410 includes moving the coated current collector substrate through an oven, furnace, or other enclosed heating environment.

Method 400 may optionally include calendering the composite electrode in step 412. The first active layer, second active layer, and separator layer may experience the calendering process as a combined structure. In some examples, calendering is replaced with another compression, pressing, or compaction process. In some examples, calendering the electrode may be performed by pressing the combined electrode layers against the substrate, such that electrode density is increased in a non-uniform manner, with the first active layer having a first porosity, the second active layer having a second porosity, and the separator layer having a third porosity. The second porosity may be lower than the first porosity and greater than the third porosity. In some examples, calendering the composite electrode further includes heating the composite electrode, such that binders included in the composite electrode coalesce.

In some examples, step 410 and step 412 may be combined (e.g., in a hot roll calendering process).

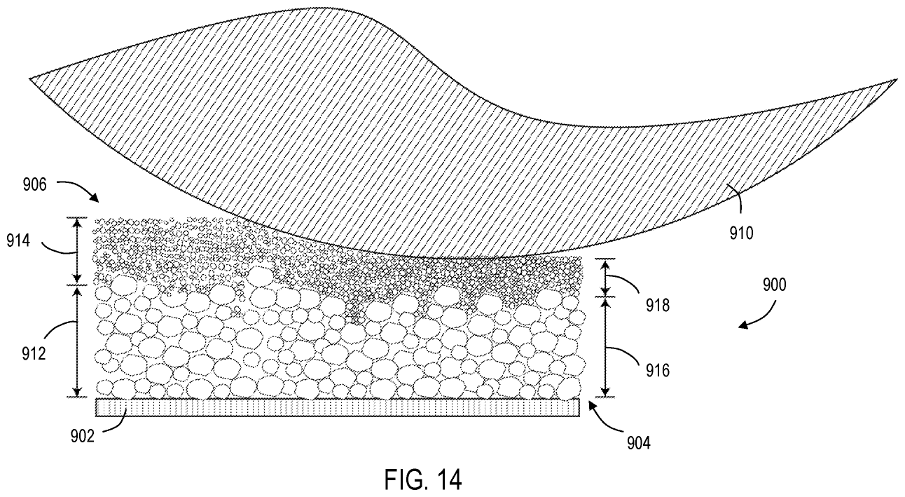

FIG. 14 shows an electrode undergoing the calendering process, in which particles in a second layer 906 (e.g., the separator layer) can be calendered with a first layer 904 (e.g., the active material layer). This may prevent a “crust” formation on the electrode, specifically on the active material layer. A roller 910 may apply pressure to a fully assembled electrode 900. Electrode 900 may include first layer 904 and second layer 906 applied to a substrate web 902. First layer 904 may have a first uncompressed thickness 912 and second layer 906 may have a second uncompressed thickness 914 prior to calendering. After the electrode has been calendered, first layer 904 may have a first compressed thickness 916 and second layer 906 may have a second compressed thickness 918. In some embodiments, second layer 906 may have a greater resistance to densification and a lower compressibility than first layer 904. After a certain level of densification, a higher tolerance to bulk compression of the separator layer may transfer a load to the more compressible electrode layer below. This process may effectively densify the anode without over densifying the separator layer. In some examples, an electrode includes three or more layers, and adjacent electrode layers transfer loads to adjacent layers below.

### E. Second Illustrative Manufacturing Method

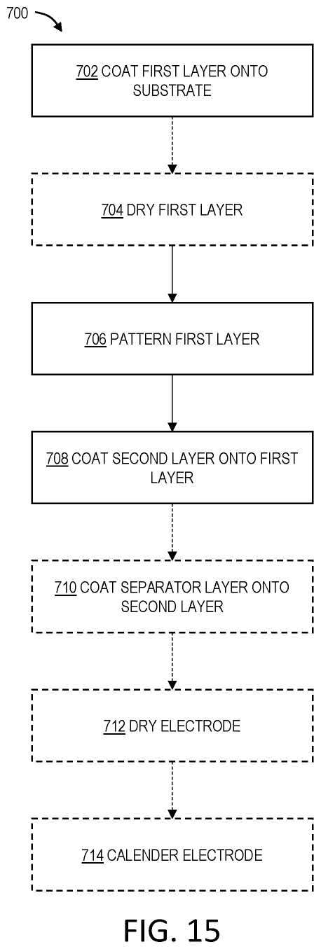

This section describes steps of an illustrative method 700 for manufacturing a patterned multilayered composite electrode; see FIG. 15. Aspects of electrochemical cell 100, electrode 200, electrode 300, patterning system 500, and patterning system 600 may be utilized in the method steps described below. Where appropriate, reference may be made to components and systems that may be used in carrying out each step. These references are for illustration, and are not intended to limit the possible ways of carrying out any particular step of the method.

FIG. 15 is a flowchart illustrating steps performed in an illustrative method, and may not recite the complete process or all steps of the method. Although various steps of method 700 are described below and depicted in FIG. 15, the steps need not necessarily all be performed, and in some cases may be performed simultaneously or in a different order than the order shown.

Step 702 of method 700 includes coating a first active layer of a composite electrode onto a first side of a substrate, forming an active material composite. The substrate may include any suitable structure and material configured to function as a conductor in a secondary battery of the type described herein. In some examples, the substrate comprises a current collector. In some examples, the substrate comprises a metal foil.

In some examples, the first active layer may include a plurality of first active material particles adhered together by a first binder, the first particles having a first average particle size (or other first particle distribution). In some examples, the composite electrode is an anode suitable for inclusion within an electrochemical cell. In this case, the first particles may comprise graphite (artificial or natural), hard carbon, lithium metal, silicon, silicon oxide, titanate, titania, transition metals in general, elements in group 14 (e.g., carbon, silicon, tin, germanium, etc.), oxides, sulfides, transition metals, halides, and/or chalcogenides. In some examples, the composite electrode is a cathode suitable for inclusion within an electrochemical cell. In this case, the first particles may comprise transition metals (for example, nickel, cobalt, manganese, copper, zinc, vanadium, chromium, iron, etc.), and their oxides, phosphates, phosphites and silicates; alkalines and alkaline earth metals; aluminum, aluminum oxides and aluminum phosphates; halides; chalcogenides, and/or the like.

Coating the substrate with the first active layer may be done by causing a current collector substrate and an electrode material composite dispenser to move relative to each other, by causing the substrate to move past an electrode material composite dispenser (or vice versa) that coats the substrate as described below. The composition of material particles in the first active layer and in subsequent electrode material composite layers may be selected to achieve the benefits, characteristics, and results described herein. The resulting electrode material composite may include one or more electrode layers, including a plurality of active material particles, and one or more separator layers, each including a plurality of inorganic material particles.

The coating process of step 702 may include any suitable coating method(s), such as slot die, blade coating, spray-based coating, electrostatic jet coating, or the like. In some examples, the first layer is coated as a wet slurry of solvent, e.g., water or NMP (N-Methyl-2-pyrrolidone), binder, conductive additive, and active material. In some examples, the first layer is coated in a dry process, as an active material with a binder and/or a conductive additive. In some examples, coating the first layer in a dry (e.g., solventless) process includes spraying the dry coating onto the substrate using any suitable method, such as electrostatically spraying, particle coating, high-velocity spraying, and/or the like.

Step 704 of method 700 may optionally include drying the first layer of the composite electrode. In some examples, drying step 704 includes a form of heating and energy transport to and from the electrode (e.g., convection, conduction, radiation) to expedite the drying process. Drying the first layer of the composite electrode may activate binders included in the first active layer, adhering the first active material particles together.

Step 706 of method 700 includes patterning the first layer of the composite electrode. In some examples, patterning the first active material layer includes adding cavities to the first active material layer by any suitable method, such as stamping, carving, boring, and/or the like. A depth of the cavities is less than or equal to a thickness of the first active material layer. The plurality of cavities may have any suitable cross-sectional shape, such as circular, elliptical, cruciform, plus-shaped, star-shaped, oblong, rectangular, square, triangular, and/or the like. In some examples, walls of the cavities may be tapered, such that a diameter of each cavity is larger at a top (e.g., outermost) of the cavity and lower at a bottom (e.g., closer to the first active material layer) of the cavity. In some examples, the cavities may be arranged to form arrays of cavities within the first active material layer.

In some examples, patterning the first active material layer includes stamping the first active material layer with embossed plates, rollers, and/or the like including arrays of protrusions. In some examples, patterning the first active material layer includes causing the electrode composite and an embossed stamp to move relative to each other. In some examples, patterning the first active material layer includes stamping the first active material layer with embossed rollers. In some examples, patterning the first active material layer includes stamping the first active material layer with embossed plates. Patterning the first active material layer may include utilizing patterning systems 500 and/or 600, as described above with respect to method 400 and depicted in FIGS. 12 and 13.

Step 708 of method 700 includes coating a second active material layer onto the first active material layer, filling the cavities of the first active material layer and forming a multilayered (e.g., stratified) electrode. Coating the second active material layer onto the first active material layer forms protrusions of the second active material layer, interlocking the first active material layer and the second active material layer. The protrusions may completely fill the cavities, forming a mechanically robust interface that is capable of withstanding stresses, such as those due to electrode expansion and contraction. Additionally, the non-planar surfaces defined by the protrusions and the cavities represent an increased total surface area of an interface boundary between the first active material layer and the second active material layer, which may provide reduced interfacial resistance and may increase ion mobility through the electrode.

The second active material layer includes a plurality of second active material particles adhered together by a second binder, the second active material particles having a second average particle size (or other second particle distribution). In some examples, the composite electrode is an anode suitable for inclusion within an electrochemical cell. In this case, the first particles may comprise graphite (artificial or natural), hard carbon, lithium metal, silicon, silicon oxide, titanate, titania, transition metals in general, elements in group 14 (e.g., carbon, silicon, tin, germanium, etc.), oxides, sulfides, transition metals, halides, and/or chalcogenides. In some examples, the composite electrode is a cathode suitable for inclusion within an electrochemical cell. In this case, the first particles may comprise transition metals (for example, nickel, cobalt, manganese, copper, zinc, vanadium, chromium, iron, etc.), and their oxides, phosphates, phosphites and silicates; alkalines and alkaline earth metals; aluminum, aluminum oxides and aluminum phosphates; halides; chalcogenides, and/or the like. In some examples, the second layer is coated as a solventless (i.e., dry) layer including a plurality of second active material particles adhered together by a second binder. In some examples, coating the second layer dry includes spraying the dry coating onto the first active material layer using any suitable method, such as electrostatically spraying, particle coating, high-velocity spraying, and/or the like. In some examples, the solventless second layer includes a conductive additive.

Step 710 of method 700 includes optionally coating a separator layer onto the second active material layer. The separator layer may include a plurality of ceramic particles adhered together by a third binder, the ceramic particles having a third average particle size (or other third particle distribution). In some examples, the ceramic particles comprise any suitable inorganic material, such as aluminum oxide (i.e., alumina (α-Al₂O₃)), corundum, calcined, tabular, synthetic boehmite, silicon oxides or silica, zirconia, and/or the like. In some examples, the separator layer is coated as a solventless (i.e., dry) layer including a plurality of ceramic particles adhered together by a third binder. In some examples, coating the separator layer in a dry process includes spraying the dry coating onto the active material composite using any suitable method, such as electrostatically spraying, particle coating, high-velocity spraying, and/or the like.

In some examples, steps 708 and 710 may be performed substantially simultaneously. For example, the slurries may be extruded through their respective orifices simultaneously. This forms a two-layer slurry bead and coating on the moving substrate. In some examples, difference in viscosities, difference in surface tensions, difference in densities, difference in solids contents, and/or different solvents used between the second active material slurry and the separator slurry or the separator slurry may be tailored to cause interpenetrating finger structures at the boundary between the composite layers. In some embodiments, the viscosities, surface tensions, densities, solids contents, and/or solvents may be substantially similar. Creation of interpenetrating structures, if desired, may be facilitated by turbulent flow at the wet interface between the second active material slurry and the separator slurry, creating partial intermixing of the two slurries.

To facilitate proper curing in the drying process, the second layer (closest to the current collector) may be configured (in some examples) to be dried from solvent prior to the separator layer (further from the current collector) so as to avoid creating skin-over effects and blisters in the resulting dried coatings.

In some examples, an optional third active material layer is included, e.g., for a total of three layers (more or fewer layers may be present). A triple slot-die coating method may be utilized for triple-layered structures. In some examples, any of the described steps may be repeated to form three or more layers. For example, an additional layer or layers may include active materials to form a multilayered electrode structure before adding the separator layer. Any method described herein to impart structure between the second active material layer and the separator coating may be utilized to form similar structures between any additional layers deposited during the manufacturing process.

Method 700 may optionally include drying the composite electrode in step 712. The first layer, second layer, and optional separator layer may experience the drying process as a combined structure. In some examples, drying step 712 includes a form of heating and energy transport to and from the electrode (e.g., convection, conduction, radiation) to expedite the drying process. In some examples, drying step 712 includes causing the coated current collector substrate to move relative to a plurality of heating elements. In some examples, drying step 712 includes moving the coated current collector substrate through an oven, furnace, or other enclosed heating environment.

Method 700 may optionally include calendering the composite electrode in step 714. The first layer, second layer, and optional separator layer may experience the calendering process as a combined structure. In some examples, calendering is replaced with another compression, pressing, or compaction process. In some examples, calendering the electrode may be performed by pressing the combined electrode layers against the substrate, such that electrode density is increased in a non-uniform manner, with the first layer having a first porosity and the second layer having a second porosity. The second porosity may be lower than the first porosity. In some examples, calendering the composite electrode further includes heating the composite electrode, such that binders included in the composite electrode coalesce.

In some examples, step 712 and step 714 may be combined (e.g., in a hot roll calendering process). The calendering process of steps 712 and 714 is similar to the example depicted in FIG. 14 and described above with respect to method 400.

### F. Illustrative Manufacturing System

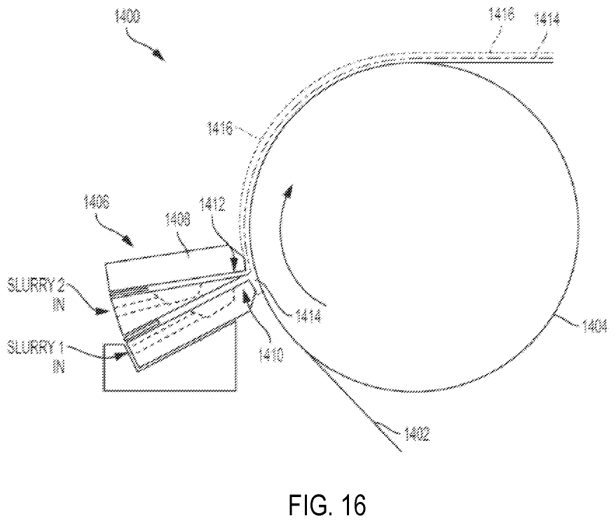

Turning to FIG. 16, an illustrative manufacturing system 1400 for use with methods 400 and 700 will now be described. In some examples, a slot-die coating head with at least two fluid slots, fluid cavities, fluid lines, and fluid pumps may be used to manufacture a battery electrode featuring an active material layer and an integrated separator layer (AKA a separator coating). In some examples, additional cavities may be used to create additional active material layers.

In system 1400, a foil substrate 1402 is transported by a revolving backing roll 1404 past a stationary dispenser device 1406. Dispenser device 1406 may include any suitable dispenser configured to evenly coat one or more layers of slurry onto the substrate. In some examples, the substrate may be held stationary while the dispenser head moves. In some examples, both may be in motion. Dispenser device 1406 may, for example, include a dual chamber slot die coating device having a coating head 1408 with two orifices 1410 and 1412. A slurry delivery system may supply two different slurries to the coating head under pressure. Due to the revolving nature of backing roll 1404, material exiting the lower orifice or slot 1410 will contact substrate 1402 before material exiting the upper orifice or slot 1412. Accordingly, a first layer 1414 will be applied to the substrate and a second layer 1416 will be applied on top of the first layer. In some examples, the first layer 1414 may be the active material of an electrode and the second layer may be a separator layer. In some examples, the first layer may be a first active material layer and the second layer may be a second active material layer.

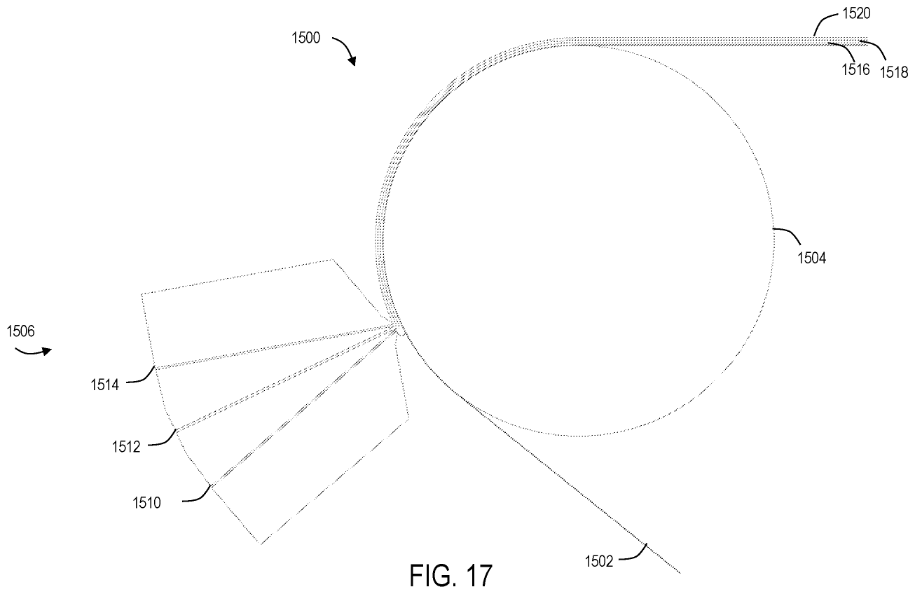

Manufacturing methods 400 and 700 may be performed using a dual-slot configuration, as described in FIG. 14, to simultaneously extrude the electrode material and the separator layer, or a multi-slot configuration with three or more dispensing orifices used to simultaneously extrude a multilayered electrode with an integrated separator layer, as depicted in FIG. 17.

In some examples, a manufacturing system 1500 (see FIG. 17) may include a tri-slot configuration, such that a first active material layer, a second active material layer, and a separator layer may all be extruded simultaneously. In another example, the separator layer may be applied after the electrode (single layered or multilayered) has first dried.

In manufacturing system 1500, a foil substrate 1502 is transported by a revolving backing roll 1504 past a stationary dispenser device 1506. Dispenser device 1506 may include any suitable dispenser configured to evenly coat one or more layers of slurry onto the substrate. In some examples, the substrate may be held stationary while the dispenser head moves. In some examples, both may be in motion. Dispenser device 1506 may, for example, include a three-chamber slot die coating device having a coating head 1508 with three orifices 1510, 1512, and 1514. A slurry delivery system may supply three different slurries to the coating head under pressure. Due to the revolving nature of backing roll 1504, material exiting the lower orifice or slot 1510 will contact substrate 1502 before material exiting the central orifice or slot 1512. Similarly, material exiting central orifice or slot 1512 will contact material exiting lower orifice or slot 1510 before material exiting upper orifice or slot 1514. Accordingly, a first layer 1516 will be applied to the substrate, a second layer 1518 will be applied on top of the first layer, and a third layer 1520 will be applied on top of the second layer.

In some examples, a first active material layer, a second active material layer, and a separator layer may all be extruded simultaneously. In some examples, an active material layer, a first separator layer, and a second separator layer may all be extruded simultaneously. In some embodiments, subsequent layers may be applied after initial layers have first dried. In some examples, some or all layers are manufactured in a dry (e.g., solventless) process. In some examples, the first and second active material layers are coated wet simultaneously and dried, and a third separator layer is dry coated onto the second active material layer once the first and second active material layers have been dried.

### G. Illustrative Combinations and Additional Examples

This section describes additional aspects and features of patterned multilayered electrodes, presented without limitation as a series of paragraphs, some or all of which may be alphanumerically designated for clarity and efficiency. Each of these paragraphs can be combined with one or more other paragraphs, and/or with disclosure from elsewhere in this application, including the materials incorporated by reference in the Cross-References, in any suitable manner. Some of the paragraphs below expressly refer to and further limit other paragraphs, providing without limitation examples of some of the suitable combinations.

A0. An electrode comprising:

a current collector;

a first active material layer disposed on the current collector;

a second active material layer disposed on the first active material layer;

a plurality of cavities formed on an exterior surface of the electrode, wherein a depth of the cavities is at least half of a thickness of the second active material layer.

A1. The electrode of paragraph A0, wherein the plurality of cavities are arranged in a symmetrical array.

A2. The electrode of paragraph A0 or A1, wherein each of the cavities has a substantially circular or elliptical cross section in a plane defined by the second active material layer.

A3. The electrode of paragraph A0 or A1, wherein each of the cavities has a cruciform cross section in a plane defined by the second active material layer.

A4. The electrode of any of paragraphs A0 through A3, wherein each of the cavities has a tapered wall.

A5. The electrode of paragraph A4, wherein each of the cavity walls is tapered such that a diameter of each cavity is larger at a surface of the electrode and smaller at an interface between the first active material layer and the second active material layer.

A6. The electrode of any of paragraphs A0 through A5, wherein the plurality of cavities are arranged in a two-dimensional array.

A7. The electrode of paragraphs A0, A1, A4, or A5, wherein each of the cavities comprises a groove extending across a width of the electrode, and wherein the grooves are arranged in a one-dimensional array.

A8. The electrode of any of paragraphs A0 through A7, wherein each of the cavities has a depth greater than a thickness of the second active material layer, such that the cavities extend into the first active material layer.

A9. The electrode of any or paragraphs A0 through A8, further comprising a third layer comprising a plurality of electrochemically inactive ceramic particles disposed on the second patterned active material layer.

A10. The electrode of paragraph A9, wherein the third layer comprises a plurality of protrusions each filling a respective one of the cavities of the second active material layer.

A11. The electrode of any of paragraphs A0 through A10, wherein depths of the cavities are non-uniform and varying.

B0. An electrode comprising:

a current collector;

a first active material layer disposed on the current collector, the first active material layer comprising a plurality of cavities formed on a top surface of the first active material layer; and

a second active material layer disposed on the first active material layer, the second active material layer comprising a plurality of protrusions interlocked with the cavities of the first active material layer.

B1. The electrode of paragraph B0, wherein the plurality of cavities are arranged in a symmetrical array.

B2. The electrode of paragraph B0 or B1, wherein a depth of each of the cavities is less than a thickness of the first active material layer.

B3. The electrode of any of paragraphs B0 through B2, wherein each of the cavities has a substantially circular or elliptical cross section in a plane defined by the first active material layer.

B4. The electrode of any of paragraphs B0 through B2, wherein each of the cavities has a cruciform cross section in a plane defined by the first active material layer.

B5. The electrode of any of paragraphs B0 through B4, wherein each cavity of the plurality of cavities has a tapered wall.

B6. The electrode of paragraph B5, wherein the each of the cavity walls is tapered such that a diameter of the cavity is larger at a top surface of the first active material layer and smaller at the current collector.

B7. The electrode of any of paragraphs B0 through B6, wherein the plurality of cavities are arranged in a two-dimensional array.

B8. The electrode of paragraphs B0, B1, B2, B5, or B6, wherein each cavity comprises a groove extending across a width of the electrode, and wherein the grooves are arranged in a one-dimensional array.

B9. The electrode of any of paragraphs B0 through B8, further comprising a third layer comprising a plurality of electrochemically inactive ceramic particles disposed on the second active material layer.

B10. The electrode of any of paragraphs B0 through B9, wherein depths of the cavities are non-uniform and varying.

B11. The electrode of any of paragraphs B0 through B10, wherein the electrode is an anode.

B12. The electrode of paragraph B11, wherein the first active material layer comprises silicon or silicon dioxide.

C0. A method of manufacturing an electrode, the method comprising:

providing a substrate;

applying a first active material layer onto the substrate, the first active material layer comprising a first plurality of active material particles and a first binder;

applying a second active material layer onto the first active material layer, the second active material layer comprising a second plurality of active material particles and a second binder;

forming a plurality of cavities on a top surface of the second active material layer by pressing an embossed mold against the electrode, wherein a depth of the resulting cavities is at least half of a thickness of the second active material layer.

C1. The method of paragraph C0, wherein the first active material layer and the second active material layer are each applied as a slurry including a solvent.

C2. The method of paragraph C1, further comprising evaporating the solvent from the first active material layer and the second active material layer before forming the plurality of cavities.

C3. The method of paragraphs C0 through C2, wherein the cavities are arranged in a symmetric array.

C4. The method of any of paragraphs C0 through C3, further comprising applying a separator layer comprising a plurality of inorganic particles and a third binder onto the second active material layer, thereby forming a plurality of protrusions interlocked with the cavities of the second active material layer.

D0. A method of manufacturing an electrode comprising:

providing a substrate;

applying a first active material layer onto the substrate, the first active material layer comprising a first plurality of active material particles and a first binder;

forming a plurality of cavities arranged in an array on a surface of the first active material layer by pressing an embossed mold against the first active material layer; and

applying a second active material layer onto the first active material layer, thereby forming a plurality of protrusions interlocked with the cavities of the first active material layer.

D1. The method of paragraph D0, wherein the first active material layer is applied as a slurry including a solvent.

D2. The method of paragraph D1, further comprising evaporating the solvent from the first active material layer before forming the plurality of cavities.

D3. The method of any of paragraphs D0 through D2, further comprising applying a separator layer comprising a plurality of inorganic particles and a third binder onto the second active material layer.

D4. The electrode of any of paragraphs D0 through D3, wherein the electrode is an anode.

D5. The electrode of paragraph D4, wherein the first active material layer comprises silicon or silicon dioxide.

### ADVANTAGES, FEATURES, AND BENEFITS

The different embodiments and examples of the patterned multilayered electrode described herein provide several advantages over electrodes. For example, illustrative embodiments and examples described herein improve adhesion between adjacent electrode layers.

Additionally, and among other benefits, illustrative embodiments and examples described herein accommodate swelling of active material particles.

Additionally, and among other benefits, illustrative embodiments and examples described herein improve ion conduction into electrode layers.

No known system or device can perform these functions. However, not all embodiments and examples described herein provide the same advantages or the same degree of advantage.

### CONCLUSION

The disclosure set forth above may encompass multiple distinct examples with independent utility. Although each of these has been disclosed in its preferred form(s), the specific embodiments thereof as disclosed and illustrated herein are not to be considered in a limiting sense, because numerous variations are possible. To the extent that section headings are used within this disclosure, such headings are for organizational purposes only. The subject matter of the disclosure includes all novel and nonobvious combinations and subcombinations of the various elements, features, functions, and/or properties disclosed herein. The following claims particularly point out certain combinations and subcombinations regarded as novel and nonobvious. Other combinations and subcombinations of features, functions, elements, and/or properties may be claimed in applications claiming priority from this or a related application. Such claims, whether broader, narrower, equal, or different in scope to the original claims, also are regarded as included within the subject matter of the present disclosure.

1. An electrode comprising:
a current collector;
a first active material layer disposed on the current collector;
a second active material layer disposed on the first active material layer; and
a plurality of cavities formed on an exterior surface of the electrode, wherein a depth of the cavities is at least half of a thickness of the second active material layer.

2. The electrode of claim 1, wherein the plurality of cavities are arranged in a symmetrical array.

3. The electrode of claim 1, wherein each of the cavities has a substantially circular or elliptical cross section in a plane defined by the second active material layer, and the cavities are arranged in a two-dimensional array.

4. The electrode of claim 1, wherein each of the cavities comprises a groove extending across a width of the electrode, and wherein the grooves are arranged in a one-dimensional array.

5. The electrode of claim 1, wherein each of the cavities has a tapered wall.

6. The electrode of claim 1, wherein each of the cavities has a depth greater than a thickness of the second active material layer, such that the cavities extend into the first active material layer.

7. The electrode of claim 1, further comprising a third layer comprising a plurality of electrochemically inactive ceramic particles disposed on the second active material layer.

8. The electrode of claim 7, wherein the third layer comprises a plurality of protrusions each filling a respective one of the cavities of the second active material layer.

9. An electrode comprising:
a current collector;
a first active material layer disposed on the current collector, the first active material layer comprising a plurality of cavities formed on a top surface of the first active material layer; and
a second active material layer disposed on the first active material layer, the second active material layer comprising a plurality of protrusions interlocked with the cavities of the first active material layer.

10. The electrode of claim 9, wherein the plurality of cavities are arranged in a symmetrical array.

11. The electrode of claim 9, wherein each of the cavities has a substantially circular or elliptical cross section in a plane defined by the first active material layer, and wherein the cavities are arranged in a two-dimensional array.

12. The electrode of claim 9, wherein each of the cavities comprises a groove extending across a width of the electrode, and wherein the grooves are arranged in a one-dimensional array.

13. The electrode of claim 9, wherein a depth of each of the cavities is less than a thickness of the first active material layer.

14. The electrode of claim 9, wherein the electrode is an anode.

15. The electrode of claim 14, wherein the first active material layer comprises a plurality of first active particles adhered together by a first binder, and wherein the first active particles comprise silicon or silicon dioxide.

16. A method of manufacturing an electrode, the method comprising:
providing a substrate;
applying a first active material layer onto the substrate, the first active material layer comprising a first plurality of active material particles and a first binder;
applying a second active material layer onto the first active material layer, the second active material layer comprising a second plurality of active material particles and a second binder; and
forming a plurality of cavities on a top surface of the second active material layer by pressing an embossed mold against the electrode, wherein a depth of the resulting cavities is at least half of a thickness of the second active material layer.

17. The method of claim 16, wherein the first active material layer and the second active material layer are each applied as a slurry including a solvent.

18. The method of claim 17, further comprising evaporating the solvent from the first active material layer and the second active material layer before forming the plurality of cavities.

19. The method of claim 16, wherein the cavities are arranged in a symmetric array.

20. The method of claim 16, further comprising applying a separator layer comprising a plurality of inorganic particles and a third binder onto the second active material layer, thereby forming a plurality of protrusions interlocked with the cavities of the second active material layer.
